(19) United States
(12) Patent Application Publication
(10) Pub. No.: US 2024/0248783 A1
(43) Pub. Date: Jul. 25, 2024

(54) ROOT CAUSE ANALYSIS VIA CAUSALITY-AWARE MACHINE LEARNING

(71) Applicant: Telefonaktiebolaget LM Ericsson (publ), Stockholm (SE)

(72) Inventors: Péter Kersch, Stockholm (SE); Zsófia Kallus, Stockholm (SE); Domokos Kelen, Stockholm (SE); Peter Vaderna, Stockholm (SE); Tamas Borsos, Stockholm (SE)

(21) Appl. No.: 18/101,274

(22) Filed: Jan. 25, 2023

(51) Int. Cl. G06F 11/07; H04L 41/16

(52) U.S. Cl. CPC G06F 11/079; H04L 41/16

(57) ABSTRACT

A system can be configured to provide root cause analysis (“RCA”) of an issue associated with a label generated by a machine learning (“ML”) model. The system can perform operations that include determining a plurality of categories associated with a plurality of features of the ML model. The operations can further include determining a causality relationship between each category of the plurality of categories. The operations can further include determining data associated with each feature of the plurality of features. The operations can further include determining the root cause of the issue using a model explainer with ordering constraints based on the causality relationship between each category of the plurality of categories. The operations can further include performing an action associated with the issue based on the root cause of the issue.

### TECHNICAL FIELD

The present disclosure is related to root cause analysis via causality-aware machine learning and more particularly to automated root cause analysis for closed-loop control of mobile networks via causality-aware machine learning explanations

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

Root cause analysis (“RCA”) can be used to determine a reason for underperformance of a telecommunications network. In some examples, RCA requires observability in multiple domains to monitor the main characteristics of performance and detect its degradation.

Several hundreds or thousands of low-level observables can be used to create a raw report on the local state of the system in a given time period, often relying on reports and asynchronous events or their statistics that are not directly related to the high-level performance indicators used to signal performance drop of the network. A diagnosis to highlight most impactful low-level observables is a non-trivial task.

The use of explainable Machine Learning (“ML”) models has been proposed for RCA. In a direct adaptation for network monitoring, a model can be trained on hundreds or thousands of network features as input to predict key performance indicators (“KPIs”) of, for example, a given network cell. For the trained ML model, model explanations highlight the specific input features responsible for a drop in performance of the physical system, and their importance in the observed degradation as compared to the typical observed state and performance baseline.

In a modified adaptation, the input features can be grouped together by functional categories, and the impact measures aggregated per category provide the final report.

In additional or alternative examples, one can change the used explainability procedure from simple naïve Shapley Additive Explanations (“SHAP”) to asymmetric SHAP, where the causality relation can be accounted for in using impact analysis of low-level features.

As an example, FIGS. 2A-B depicts a case of naïve SHAP explanations for low “Downlink throughput” performance. In FIG. 2A, the features are grouped into radio access network (“RAN”) domains and their aggregated effects are considered with respect to the Downlink throughput performance label. FIG. 2B illustrates an example of simple explanations for a cell performance drop in Downlink throughput explained by input features from three domains by naïve feature impact aggregation. The explanations divide the overall degradation from the baseline performance of the cell into relative weights of each domain—as aggregated from the feature explanations of their respective domain's features. However, this feature aggregation often proves to be misleading as the ML model is explained without connecting diagnosis to the structure of the physical system and the processes linking its components.

### SUMMARY

According to some embodiments, a system configured to provide root cause analysis (“RCA”) of an issue associated with a label generated by a machine learning (“ML”) model is provided. The system includes processing circuitry and memory coupled to the processing circuitry. The memory includes instructions stored therein that are executable by the processing circuitry to cause the system to perform operations. The operations include determining a plurality of categories associated with a plurality of features of the ML model. The operations further include determining a causality relationship between each category of the plurality of categories. The operations further include determining data associated with each feature of the plurality of features. The operations further include determining the root cause of the issue using a model explainer with ordering constraints based on the causality relationship between each category of the plurality of categories. The operations further include performing an action associated with the issue based on the root cause of the issue.

According to other embodiments, a method of operating an explainer with ordering constraints for a machine learning (“ML”) model is provided. The method includes determining an issue associated with a label of the ML model based on input data, the input data associated with a plurality of categorized features. The method further includes determining a root cause of the issue based on a causality relationship between the plurality of categorized features. The method further includes performing an action based on the root cause of the issue.

According to other embodiments, a system, an explainer, a network node, a host, a computer program, a computer program product, or a non-transitory computer readable medium is provided to perform one of the above methods.

Certain embodiments may provide one or more of the following technical advantages. The proposed solution automatically identifies root causes for KPI changes and also quantifies their impact contributions. Only root causes are highlighted—unlike with “traditional explainers” providing an indeterministic mix of impact contribution from both root causes and more direct factors or misleading correlations. Scalable solution, without loss of information on known causality relations. The system is fully model agnostic: i.e., any ML models can be used as base models (in the PoC, gradient boosted trees are used but neural network or any other technology could have been used as well). To overcome simple collaborative game theory approach of fair distribution of feature impacts in explainable ML, causality-aware XAI-based RCA can be used for mobile networks. To overcome explosion of problem complexity in typical causality models, scalable methods presented by use of mid-level causality graph node definition, hence suitable for various KPI use cases. Actionable RCA output is related to control loop receivers in the knowledgebase, and includes types of action on most impactful CM, PM, or latent observables as well. Automation without losing trustworthy aspects: expert supervision can be included both: 1) In causality graph structure to describe input feature functional relations, and 2) In automation control loops which are the receiver of the RCA output.

In some embodiments, there is an evolution over automated rule-based alerts, as ML models can consider diverse factors without simplification. In additional or alternative embodiments, KPI drops caused by latent features cam be identified and used to quantify the value of expanding observed features by additional ones—useful, e.g., for decision on paid subscription to specific network or environment observables. In additional or alternative embodiments, re-evaluation and re-training can be triggered in ML ops automated control loops.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

FIGS. 2A-B are block diagrams illustrating examples of an explanation for cell performance drop in downlink throughput;

FIG. 3 is a block diagram illustrating an example of a summary of explainable AI models derived from Shapley values of game theory;

FIG. 4 is a flow diagram illustrating an example of challenges of automating actionable RCA;

FIGS. 5A-B are block diagrams illustrating examples of a difference between conventional and causality-aware explanations for the same case of cell performance drop;

FIG. 6 is a flow diagram illustrating an example of a functional causality graph in accordance with some embodiments;

FIG. 7 is a block diagram illustrating an example of a causality graph example for RAN domain in accordance with some embodiments;

FIG. 8 is a block diagram illustrating an example of an implementation of the diagnostic method for causality-aware explanations of RCA for RAN optimization in accordance with some embodiments;

FIGS. 9A-C are block diagrams illustrating examples of a comparison of expected versus real explanations for RCA in accordance with some embodiments;

FIG. 10 is a block diagram illustrating an example of an automated diagnostics for control of Mobile Networks via causality-aware ML in accordance with some embodiments;

FIG. 11 is a flow chart illustrating an example of operations performed by a system in accordance with some embodiments;

FIG. 12 is a block diagram of a communication system in accordance with some embodiments;

FIG. 13 is a block diagram of a user equipment in accordance with some embodiments

FIG. 14 is a block diagram of a network node in accordance with some embodiments;

FIG. 15 is a block diagram of a host, which may be an embodiment of the host of FIG. 12, in accordance with some embodiments;

FIG. 16 is a block diagram of a virtualization environment in accordance with some embodiments; and

FIG. 17 shows a communication diagram of a host communicating via a network node with a user equipment over a partially wireless connection in accordance with some embodiments.

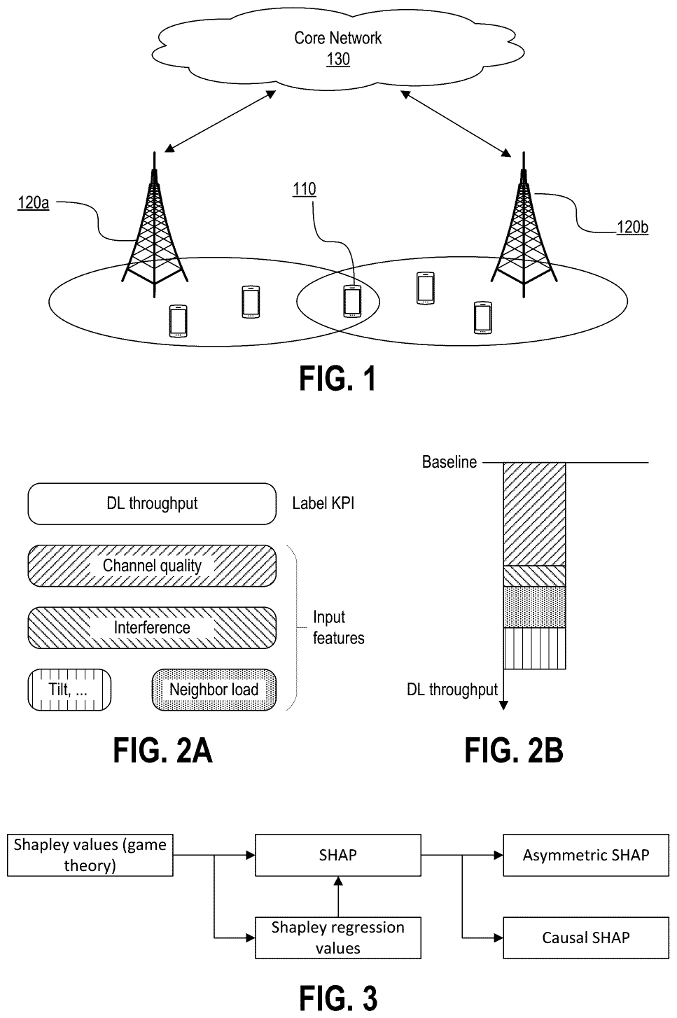

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

FIG. 3 summarizes the various available procedures and their relations starting from the original work of Shapley in cooperative game theory. This work aimed at fair distribution of “payout” by creating an additive measure of contribution for individual player in a team. By considering their added value in all possible coalitions (e.g., quantifying the interactions between players that lead to a game outcome), “Shapley regression values” were defined for importance of correlated input features.

The Shapley Additive Explanations (“SHAP”) metric is widely used for additive feature explanation of general ML models, and the procedure is derived from these original works.

The basic procedure of determining SHAP values ignores all causal relationships as it equally distributes attributions over identically informative features and attributes zero impact to missing features. This might explain a machine learning (“M”) model's logic but will not differentiate between causal effects and correlations. Hence, there are efforts to define novel explanation metrics for causality-aware analysis, for example, Asymmetric SHAP and Causal SHAP.

An asymmetric SHAP procedure can be defined by leaving the symmetry property of SHAP values (e.g., the contribution of features may not be equal anymore if they contribute equally to all coalitions). Instead, to emphasize root causes and not immediate causes, they use probability weighting in the summation of all contributions based on causality relations of the features.

Causal SHAP metric can incorporate Pearl causal calculus to account for indirect and direct effects when quantifying the importance of a feature with regards to the final prediction of a model.

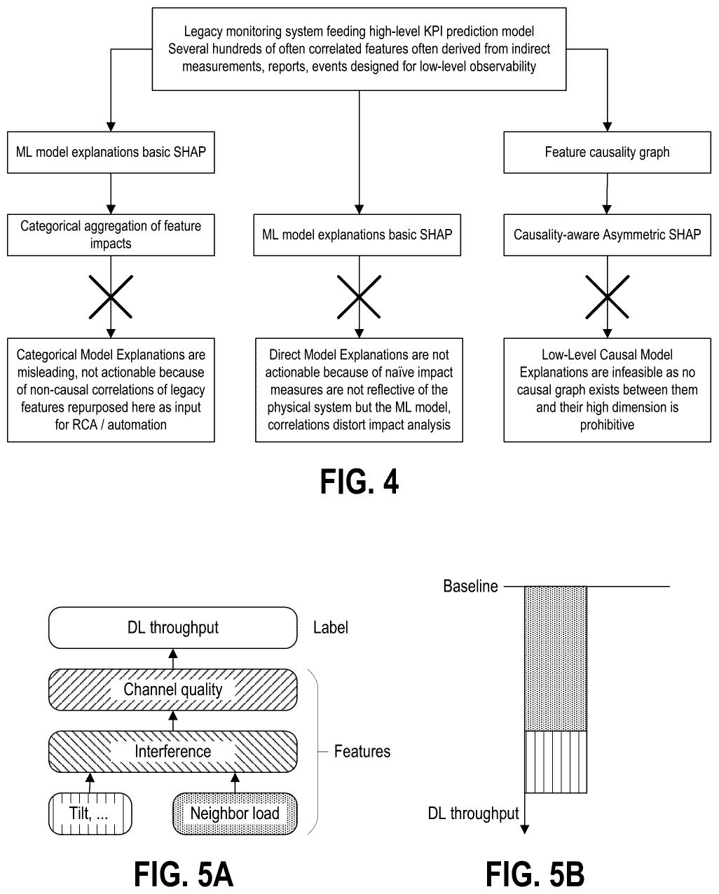

There currently exist certain challenges. Because of complexity, scale, and indirect state observability, simple adaptations of Explainable Artificial Intelligence (“XAI”) for Root Cause Analysis (“RCA”) procedures can fail to provide actionable RCA results. FIG. 4 illustrates an example of challenges of such an automated actionable diagnostic analysis via explainable ML techniques. The monitoring relies on mostly indirect measurements often of a legacy system components and asynchronous multi-domain reporting events. Observability and causality relations may not be fully resolved on the level of raw reported features. Hence, existing procedures can fall short of enabling functional root cause analysis and hence, may not provide actionable insights.

In regards to RCA used for mobile networks, additional challenges may exist. In some examples, the explanation techniques can rely on complex, hard-to-scale game theoretic or causal inference measures, or misleading simple feature correlations. In additional or alternative examples, the causality graph between features and performance metrics describing the relations and hierarchy of the high-dimensional observable network state are considered fully known.

Without the complex causality relations among highly correlated features, explanations can ultimately provide a mix of root cause impacts and other more direct impacts—their share being heavily model dependent. Hence, without causality-aware explanations, the result can only be used for human supervision of ML-based predictive models, but they will be false and misleading for automated response.

On the other hand, direct inference of complex causality relations, even if all observable, quickly explode in problem complexity as a basic network state will be represented by several hundreds of monitoring features.

For the previous RAN example, FIGS. 5A-B depicts a case of misleading explanations for low Downlink throughput performance resulted, in reality, from high cell load in neighboring cells and overlapping coverage areas causing performance degradation via interference. An example is illustrated of a difference between conventional and causality-aware explanations for the same case of cell performance drop. When model explanations are used for Root Cause Analysis, conventional explainers need to be replaced by causality aware methods, where simple correlations are replaced by causal relations of the input features and performance metric.

In addition, the readily available extended causal SHAP metrics are not suitable for direct implementation in RCA for mobile network use cases. They fall short on many technical aspects. In some examples, scaling properties for high-dimensional input feature spaces are important, as several hundreds of descriptors are generated in a telco network. In additional or alternative examples, only partial information is available for both the state descriptor features and the causality relationships between them. Without a pre-processing feature engineering step, the ML models need to work on correlated features with both redundant and interaction information present, providing misleading results on telco data.

Certain aspects of the disclosure and their embodiments may provide solutions to these or other challenges. In some embodiments, automated root cause analysis is proposed for diagnosis of performance degradation providing actionable insights on the state of the physical system of complex telco networks. To leverage indirect analytics from diverse monitoring components and the limited knowledge of functional structure of the interactions of low-level physical observables, impact profiles can be created only on the level of domain categories. This methodology can adapt causality-aware ML explanations, where actionable root cause impact reports are output towards corresponding target control loop modules to resolve network performance degradation or further optimize monitoring.

In some examples, questions like “What are the root causes of very low throughput in a specific cell?” can be automatically answered. System parameter setting, system design changes, or even monitoring system enrichment can be automatically determined solve to root causes of the problem.

For a specific use case, a key performance indicator (“KPI”) is used as label, and observation input vectors describing mobile network system state at a given time interval are used to train ML models for KPI prediction. A KPI can be defined as simple or complex, e.g., as a weighted sum of simple high-level KPIs.

For a mobile network use case, a domain-level causality graph is created between the relevant mobile network domains. Directed links represent their causality relations according to their impact on the selected KPI. Causality relations are differentiated from simple correlations. Role of external latent variables is also considered.

This knowledge graph representing the functional structure of the observable system state is a result of semantic feature categorization used to create directed causality graph only between higher-level aggregated nodes.

These feature category subsets form functional groups of low-level features with known potential for action type to be performed in case of KPI degradation caused by their impact.

This functional aggregation is needed before forming the causality graph as causal relations between the hundreds or thousands of low-level features are unknowable, and the problem size is also rendering RCA practically infeasible at low level.

The initial graph can be created by telco experts and its update can be triggered automatically, e.g., as the system and service patterns evolve over time or imperfections are uncovered by.

To explain KPI degradation by root causes instead of explaining a general ML model's internal logic, a scalable causality-aware explanation can be described as follows: 1) To keep complexity under a compute efficiency threshold, a problem space division can be based on the domain hierarchy, and training of sub-models only for valid causality orderings; and 2) Asymmetric-SHAP is calculated by training base models for all possible topological ordering prefix sets and computing the incremental contribution of each feature category for each topological ordering by subtracting outputs of the respective two base models.

The proposed system provides automated root cause analysis (RCA) of performance and quality of experience issues in mobile networks.

This is achieved using explainable ML models learning how key performance indicators (KPIs) are impacted by different factors (input features of the model) in the complex telco system—taking also into account causality relationships between these factors. The method enables actionable impact report on system state and automatic triggers for knowledge graph updates as well.

The enabler methodology is a clever combination of three key technology components: 1) Semantic categorization of input features is used as input for functional representation of the system. Including latent features with partial or external data streams and non-continuous observability; 2) Definition of causality relationships only on the level of the domain categories (and NOT between individual features) to create a causal knowledge graph as a functional representation of the system.

Corresponding Action types (or report receiver types) are also included in system description to easily translate RCA output impact analysis into actions in control loops; and 3) Using Asymmetric SHAP as model explainers with ordering constraints from causality defined between feature categories (and NOT between individual features), providing scalable solution feasible on telco network problem size and complexity, including with legacy monitoring features.

More in detail, defining causality relationships between feature categories (instead of individual features) is critical for two reasons: 1) for highly correlating features describing slightly different aspects of the same thing (very common in telco systems), it is typically not possible to define clear causality relationships; and 2) for hundreds or thousands of features, it is practically not feasible to create and maintain a full causality graph. Even if this was possible, it would not be feasible to derive Asymmetric SHAP where computational complexity increases exponentially by the number of features. Working with dozens of feature categories instead of hundreds or thousands of features, all this becomes manageable.

By using functional system representation and potential action types in knowledge graph of domains, the RCA results can be integrated into either automated or expert-supervised control loops, which also includes triggers for the monitoring system to extend observability, e.g., when latent variable data stream activation is needed, or update or review triggers for the knowledge graph, e.g., when outlier explanation patterns appear compared to historical records.

According to other embodiments, a communication device, a network node, a computer program, a computer program product, a non-transitory computer readable medium, a host, or a communication system is provided to perform the method above.

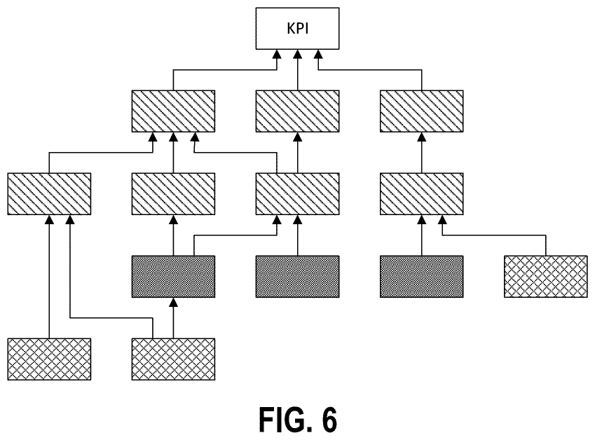

In some embodiments, the input system representation is a functional domain-level causality graph connecting feature categories (e.g., as illustrated in FIG. 6). It can be manually built, e.g., by RAN experts, from observable and latent features and automatically updated when contradiction is found or the system changes. The graph links represent causal relationships between the functional domain categories with respect to the high-level KPI. It is a directed acyclic graph where the KPI depends directly on several feature categories, these categories depend on further feature categories, etc. Different types of features are distinguished: 1) Performance Management (PM) metrics: they characterize users' activities (e.g., service consumption, generating traffic, mobility) and network measurements (e.g., cell load, radio quality, service performance); 2) Configuration Management (CM) parameters: Network configuration parameters related to e.g., spectrum, antenna, cell dimensioning; and 3) Latent parameters: these are not measured but it is possible to switch on data collection. For example, a licensed measurement report is not activated, or 3rd party data service is disabled.

There are certain nodes in the graph that do not depend on any other parameters, they represent typically CM and latent parameters.

The presented method builds on knowledge representation of AI and telco system domains. Once it is possible to start from a sufficiently good quality causality representation and category definitions tested on explanation of training observations, continuous feedback from the impact analysis can further improve the causality graph during inference phase—e.g., to handle the shift in the RAN state or some monitoring conditions. For new network rollouts, local trial period can avoid cold starts by transfer learning methods.

FIG. 6 illustrates an example of a functional causality graph. Links shown between three types of categories with different action report receivers. High-level KPI impacts are considered for each use case, including impact from latent, unknown features that could enrich the monitoring of system state.

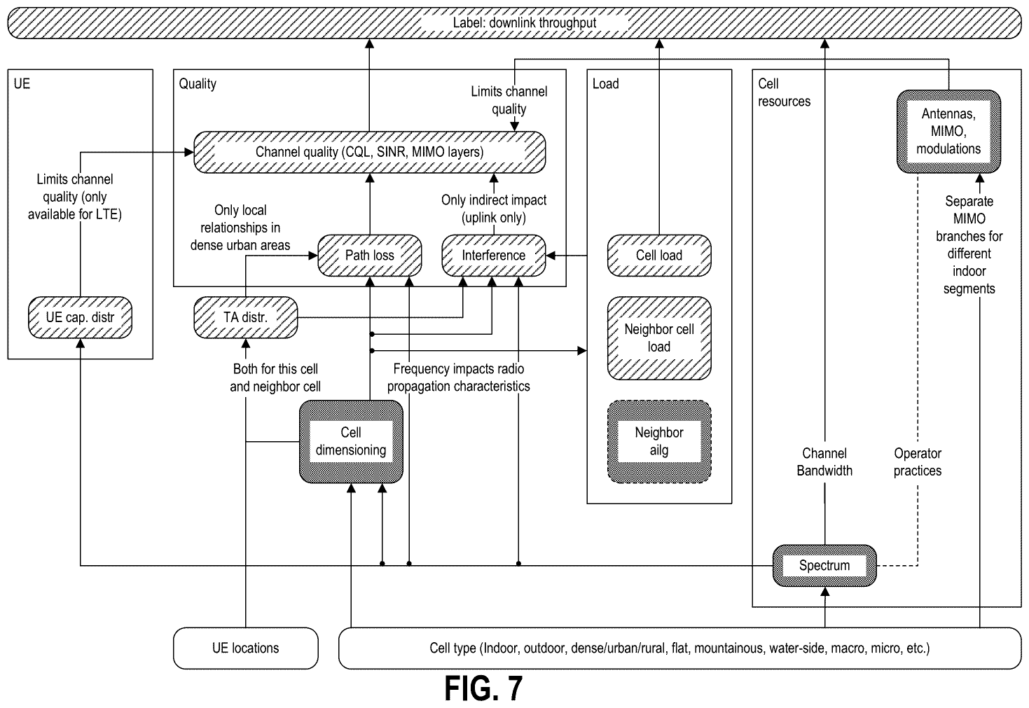

FIG. 7 illustrates an example of a causality graph example for RAN domain. Representing the RAN functional knowledge of the system structure by grouping to domains of observable and latent features to explain degradation in “Downlink throughput”. Differentiation is depicted for observable sources (CM, PM, latent) and impact relation types (causation, only correlation).

After the RCA is performed, different actions trigger reports can be sent to corresponding control loops for system performance optimization: 1) One type of action is to change a CM parameter. There is a selected set of CM parameters that can be changed in an optimization process. When one of the CM parameters from the selected set is highlighted as the most impacting feature, an action can be to change this CM feature to the direction where the KPI is expected to be improved. This type of action trigger will be sent to the optimization module responsible for control of the specific CM parameters. E.g., mobility optimization, power optimization, coverage optimization by antenna tilt setting; 2) Another type of action proposal can be to adjust the system to new service conditions as seen in PM parameters. This type of action trigger will be sent to the optimization module responsible for control of the specific PM parameters (e.g., optimization of the spatial structure or capacity distribution of the network by new installations); and 3) Another type of action is for the monitoring system to switch on the measurements/collection of certain latent features. When the RCA determines the main impacting feature and that depends further on latent features, the monitoring of those latent features is switched on to improve observability. This type of action trigger will be sent to the optimization module responsible for the monitoring system to further enrich observability.

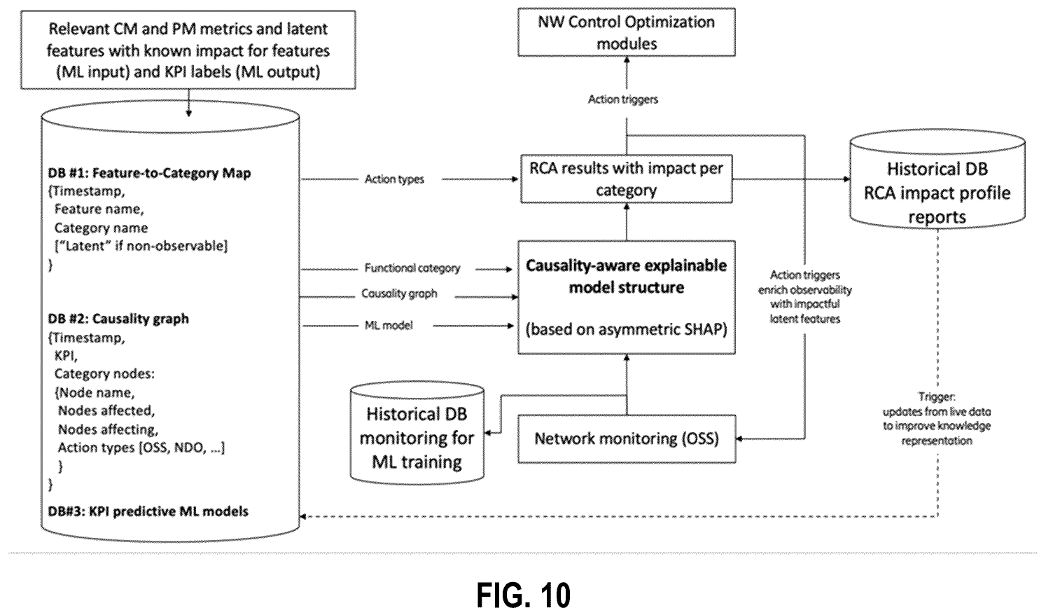

FIG. 10 illustrates an example of how this knowledge can be represented in one embodiment.

The PoC was an example of RCA in RAN as illustrated in FIG. 7.

Input feature types in the provided example of Downlink throughput explanations: Based on their source, the system provides CM data and PM data; Further engineered features can be added (e.g., handover weighted loads for neighbor scenarios); and the state is also dependent on external latent features.

The first two types represent internal observables of the system, while latent variables are known as potential root cause features from which the effect is only observable through secondary CM or PM variables or not at all as they are observable but missing from the monitoring system used. Latent variables would need to be enriched to internal feature set and correlated per cell from external sources for a direct analysis.

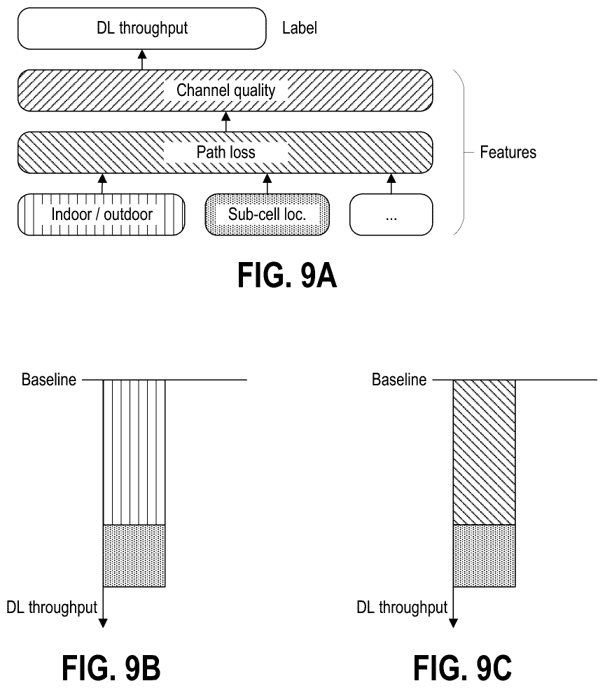

In some examples, four high-level domains are subdivided into mid-level categories as follows (as illustrated in FIGS. 5A-B): 1) UE (e.g., UE cap. Distr.); 2) Quality (e.g., path loss; interference with only indirect impact (uplink only); channel quality descriptors: CQI, SINR, MIMO Layers); 3) Load (e.g., Cell load, Neighbor cell load, Neighbor air interface load generator (ailg.)); 4) Cell resource (e.g., Spectrum, Radio system descriptors: Antennas, MIMO, modulations); 5) Sub-cell location (e.g., Timing advance (distance estimates from tower using radio propagation time (TA distr.)); 6) Cell dimensioning (e.g., both for the analyzed cell and its neighboring cells); and 7) Latent features (e.g., UE locations, Cell type descriptors (indoor/outdoor, dense/urban/rural, flat/mountainous/water-side, macro/micros, etc.)). Although latent features are also depicted as their effect is often non-negligible in RCA for RAN, they were not available in the POC analysis. Their per cell correlation to the internal observables event time series can require different technologies based on data owners and dynamic/static properties of these descriptors. However, the proposed method was able to yield the first observable category in the causality graph for the latent root causes. See PoC description, FIG. 9.

Embodiments associated with implementation of diagnostic methodology based on causality-aware Explainable ML in Mobile Network use cases are described below.

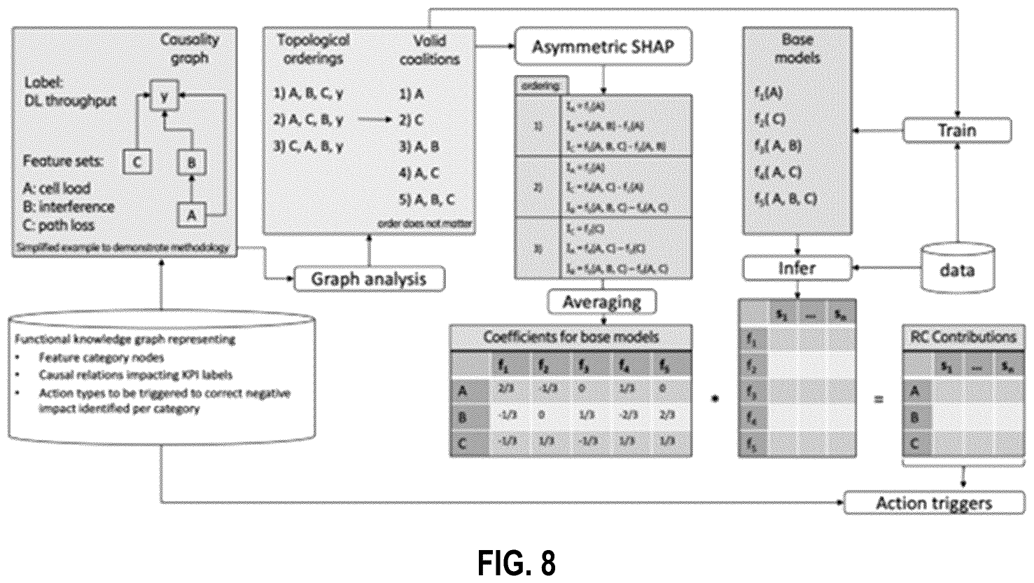

In some embodiments, a novel efficient explanation methodology for automation of RCA is provided by adapting advanced SHAP analysis of ML models trained to predict KPIs from observable Mobile Network state in a scalable way using available observability features. FIG. 8 illustrates a procedure based on asymmetric SHAP, relying on compact causality graph created for the use cases. A simplified view of the proposed causality graph is depicted as input information. Domain sets form the nodes (A-C) in the causal topology with respect to the performance metric (y) to be predicted, here “DL throughput” use case. It is used as a label in the ML training set of observations and is the highest level of the directed graph, i.e., the root of the tree. The steps are detailed in the description.

FIG. 8 includes feature categories (A, B, C); a label (y) (e.g., a KPI used as the label of the predictive ML model); a calculated marginal impact (Iₓ) of feature group x when using the specific topological ordering; base model (fᵢ) using the i^{th} feature subset; an i^{th} sample (sᵢ) for which computation of root cause contributions is desired.

In some embodiments, a Causality Graph is used between domain-specific feature sets. As the full causality graph learning task is too complex for efficiently learning the graph structure automatically, a high-level functional categorization and causality graph can be used as initial expert input. It has to represent only relations between feature sets of same proposed mid-level technical domain or category. Details were presented above, with illustration of FIGS. 6-7.

In additional or alternative embodiments, graph analysis can be used to create the list of causal topological orderings. For example, all possible graph node orderings from leaves to the root (label) to reach the label without going against the directed edges. This can be necessary for the Asymmetric SHAP calculations, where the corresponding valid feature coalitions are considered.

In additional or alternative embodiments, base models can be trained for each feature set. These models are trained to highest achievable accuracy for the KPI label of interest, but only using a given partial input feature set. Their Inference outputs can then be considered for baselines or ground truths, for calculating added feature contributions in next steps of causal explanations.

In additional or alternative embodiments, asymmetric SHAP calculus can be used for valid causal orderings: The causal graph is used to avoid explosion of problem complexity, a bottle neck in scaling by number of input features. By keeping the number of causal graph nodes under a threshold of 10 to 20 (for a graph structure similar to the PoC example), we effectively introduce technical domain walls according to a given label KPI within the space of all possible non-causal topologies. With this causality-aware partitioning created per use case, direct Asymmetric SHAP calculation can be leveraged. Impacts are then expressed by differences, quantifying the node's additive impact (Iₓ on FIG. 8) with respect to parent feature set impact. When the number of nodes is not kept under the practical threshold, a random sampling of all possible topological orderings between them can be used for efficient representation.

In additional or alternative embodiments, efficient calculus of causality-aware RCA explanations can be used for a Mobile Network. In some examples, a Table of Coefficients is introduced after averaging over the very sparse base matrices calculated from the different topological orderings. These Coefficients are used for weighted averaging of feature contributions based on all valid causal orderings in the graph. The rows represent the feature sets, and the columns represent the base models. The final Root Cause Contributions or impacts per node are then calculated by efficient matrix product by the base model impacts (sᵢ in FIG. 8).

In additional or alternative embodiments, actions are triggered: matching the knowledge base of category action types or receiver control loops and the result of the RCA impact analysis of the features, actionable reports can be delivered to the corresponding control loops.

In some examples, during peak hours, the root cause of performance degradation is high load in the NR and LTE cell sharing the same spectrum. High load in neighbor cells+higher ratio of cell edge users causes also performance degradation via interference. Causality-aware model structure highlights root cause. Conventional flat model structure distributes impact attributions in a non-deterministic way between feature categories on different levels of the causality graph.

In some embodiments, supplementary illustration of latent features highlighted in as root causes with known effect but without observability at the time of first KPI degradation is detected. In some examples, indoor/outdoor usage is not directly observable in mobile networks. Therefore, degradations due to indoor usage will be tagged as degradations due to higher path loss. These mid-level results can trigger enrichment of monitoring input streams if the KPI degradation's impact is in balance with increased costs.

FIGS. 9A-C illustrate an example of a comparison of expected vs. real explanations for RCA in a case of impactful latent features of known effect in the causality graph between domain nodes but without observability.

FIG. 10 illustrates an example of automated diagnostics for control of Mobile Networks via causality-aware ML. The illustrated procedure introduces a knowledge representation scalable for complex telco system description for functional impact analysis with actionable root cause analysis.

The feature to category map can be initially created, e.g., by domain experts of impacts on a given KPI by low-level observable and latent features describing indirectly the state of the network.

The functional causality graph is defined by category nodes, their impact relations to other domain categories form the links of the causality graph.

The category action property of the nodes points towards the potential receiver control module types that can be triggered/alerted when negative impact is detected from a given root cause category in case of KPI degradation.

The monitoring system can also be triggered for enrichment by missing impactful latent root cause features.

In addition, the knowledge base itself can be triggered for an update if historical records of impact patterns and the resulting RCA show contradictory impact profile, e.g., indicate outlier RCA result while same conditions present, or, e.g., mid-level categories have high impact reported without latent category at lower root cause levels.

Knowledge base can also be basis for transfer learning to avoid cold starts, and it can be used, e.g., after new system rollout, changes in predictive ML models, changes in observability of the system, or end-user behavior, or incremental changes in the network. After initial graph creation, re-evaluation can be initiated by automatic triggers.

The RCA output is an impact profile, where category aggregations are meaningful as quantified negative impact of actionable root causes.

Historical databases are collected, e.g., for profile pattern recognition, impact profile outlier detection, knowledge transfer and ML model retraining when concept shift is detected. The training loop of the used KPI predictive models can be on relevant collected database or even synthetic simulated data.

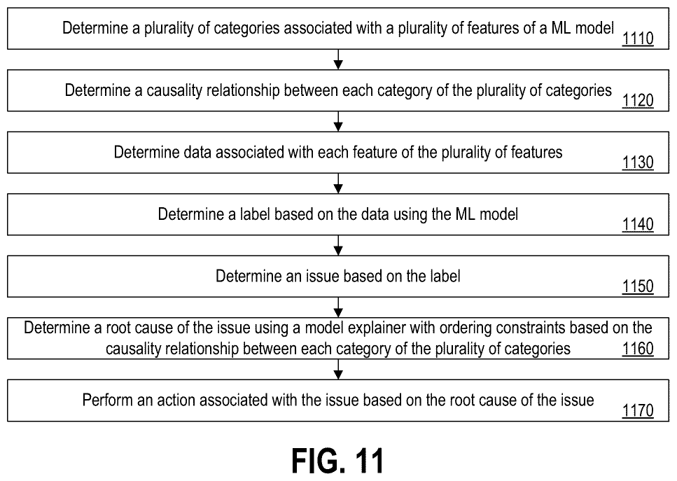

Operations of the RAN node 1400 (implemented using the structure of FIG. 14) will now be discussed with reference to the flow chart of FIG. 11 according to some embodiments of inventive concepts. For example, modules may be stored in memory 1404 of FIG. 14, and these modules may provide instructions so that when the instructions of a module are executed by respective RAN node processing circuitry 1402, RAN node 1400 performs respective operations of the flow chart.

At block 1110, processing circuitry 1400 determines a plurality of categories associated with a plurality of features of a ML model. In some embodiments, the ML model is based on a communications network. In some examples, the plurality of features include at least one of: a performance management (“PM”) metric associated with an activity of a communication device in the communications network; a configuration management (“CM”) metric associated with a parameter of the communications network; and a latent parameter that is not currently measured. In additional or alternative examples, the PM metric includes at least one of: service consumption; traffic generated; mobility; cell load; radio quality; and service performance. The CM metric includes at least one of: spectrum; antenna configuration; and cell dimensioning. The latent parameter includes at least one of: a licensed measurement report; and a third party data service.

At block 1120, processing circuitry 1400 determines a causality relationship between each category of the plurality of categories.

At block 1130, processing circuitry 1400 determines data associated with each features of the plurality of features. In some embodiments, determining the data includes at least one of: measuring the data; and receiving the data from a node.

At block 1140, processing circuitry 1400 determines a label based on the data using the ML model.

At block 1150, processing circuitry 1400 determines an issue based on the label.

At block 1160, processing circuitry 1400 determines a root cause of the issue using a model explainer with ordering constraints based on the causality relationship between each category of the plurality of categories. In some embodiments, determining the root cause of the issue comprises using an asymmetric Shapley Additive Explanation (“SHAP”) as the model explainer with ordering constraints from the causality relationship between each category of the plurality of categories.

At block 1170, processing circuitry 1400 performs an action associated with the issue based on the root cause of the issue. In some embodiments, the issue includes an issue in a communications network. In some examples, performing the action includes transmitting instructions to a network node to reconfigure the communications network to reduce the issue. The network node can include a core network (“CN”) node; a radio access network (“RAN”) node; a RAN controller; or an orchestrator. In additional or alternative examples, performing the action includes outputting an indication to a network operator. The indication includes at least one of: a latent feature of the communications network that had at least a threshold impact on the issue; a suggested reconfiguration of the communications network; and an amount that a feature of the plurality of features affected the issue. In additional or alternative examples, performing the action includes requesting additional data associated with a specific feature of the communications network.

Although FIG. 11 is described above as being performed by a network node, the operations may be performed by any suitable system and/or device. For example, the operations may be performed by an explainer for a ML model.

Various operations from the flow chart of FIG. 11 may be optional with respect to some embodiments.

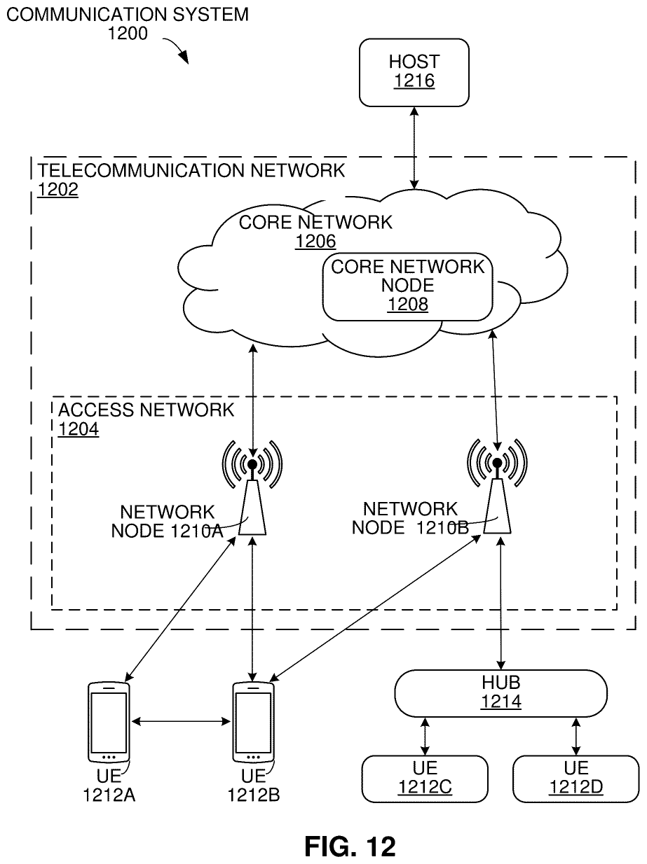

FIG. 12 shows an example of a communication system 1200 in accordance with some embodiments.

In the example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3rd Generation Partnership Project (3GPP) access node or non-3GPP access point. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

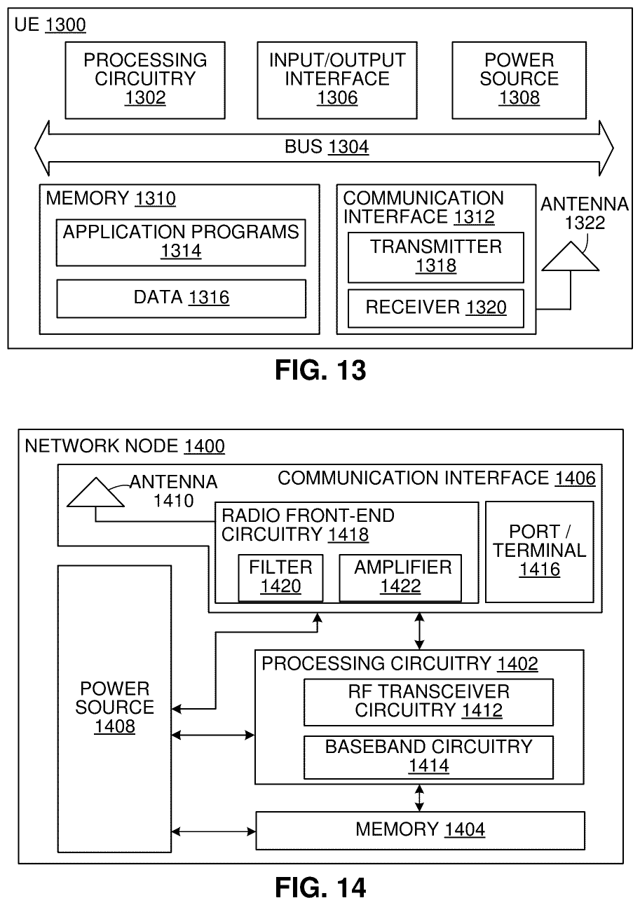

FIG. 13 shows a UE 1300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging of the power source 1308. Power circuitry may perform any formatting, converting, or other modification to the power from the power source 1308 to make the power suitable for the respective components of the UE 1300 to which power is supplied.

The memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1310 may allow the UE 1300 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 1400 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1400 includes a processing circuitry 1402, a memory 1404, a communication interface 1406, and a power source 1408. The network node 1400 may be composed of multiple physically separate components (e.g., a NodeB component and a RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, to provide network node 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network node 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, communication interface 1406, and/or the processing circuitry 1402 may be configured to perform any receiving operations and/or certain obtaining operations described herein as being performed by the network node. Any information, data and/or signals may be received from a UE, another network node and/or any other network equipment. Similarly, the antenna 1410, the communication interface 1406, and/or the processing circuitry 1402 may be configured to perform any transmitting operations described herein as being performed by the network node. Any information, data and/or signals may be transmitted to a UE, another network node and/or any other network equipment.

The power source 1408 provides power to the various components of network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

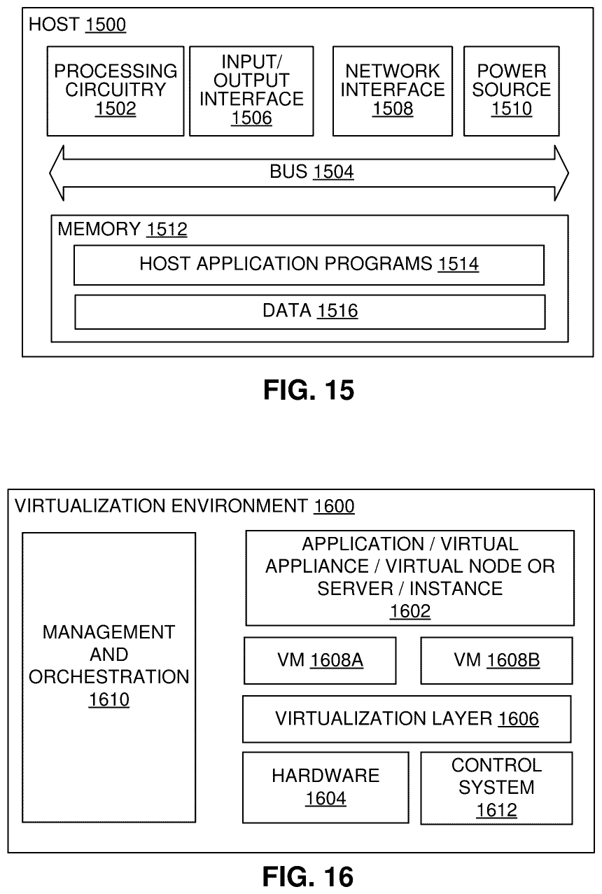

FIG. 15 is a block diagram of a host 1500, which may be an embodiment of the host 1216 of FIG. 12, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top (OTT) services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g. such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

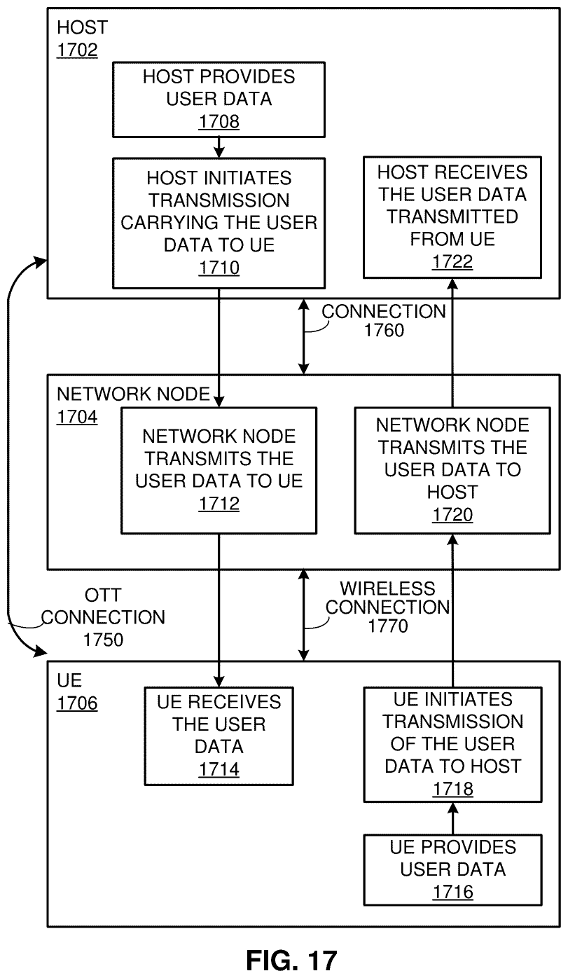

FIG. 17 shows a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

One or more of the various embodiments improve the performance of OTT services provided to the UE 1706 using the OTT connection 1750, in which the wireless connection 1770 forms the last segment. More precisely, the teachings of these embodiments may improve RCA of an issue associated with a label of a ML model.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results. The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc.; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

What is claimed is:

1. A system configured to provide root cause analysis (“RCA”) of an issue associated with a label generated by a machine learning (“ML”) model, the system comprising:
processing circuitry; and
memory coupled to the processing circuitry and having instructions stored therein that are executable by the processing circuitry to cause the system to perform operations comprising:
determining a plurality of categories associated with a plurality of features of the ML model;
determining a causality relationship between each category of the plurality of categories;
determining data associated with each feature of the plurality of features;
determining the root cause of the issue using a model explainer with ordering constraints based on the causality relationship between each category of the plurality of categories; and
performing an action associated with the issue based on the root cause of the issue.

2. The system of claim 1, wherein determining the root cause of the issue comprises using an asymmetric Shapley Additive Explanation (“SHAP”) as the model explainer with ordering constraints from the causality relationship between each category of the plurality of categories.

3. The system of claim 1, further comprising:
determining a label based on the data using the ML model; and
determining the issue based on the label.

4. The system of claim 1, wherein the issue comprises an issue in a communications network.

5. The system of claim 4, wherein performing the action comprises:
transmitting instructions to a network node to reconfigure the communications network to reduce the issue.

6. The system of claim 5, wherein the network node comprises at least one of:
a core network (“CN”) node;
a radio access network (“RAN”) node;
a RAN controller; and
an orchestrator.

7. The system of claim 4, wherein performing the action comprises:
outputting an indication to a network operator, the indication comprising at least one of:
a latent feature of the communications network that had at least a threshold impact on the issue;
a suggested reconfiguration of the communications network; and
an amount that a feature of the plurality of features affected the issue.

8. The system of claim 4, wherein performing the action comprises:
requesting additional data associated with a specific feature of the communications network.

9. The system of claim 4, wherein determining the data comprises at least one of:
measuring the data; and
receiving the data from a network node of the communications network.

10. The system of claim 4, wherein the plurality of features comprise at least one of:
a performance management (“PM”) metric associated with an activity of a communication device in the communications network;
a configuration management (“CM”) metric associated with a parameter of the communications network; and
a latent parameter that is not currently measured.

11. The system of claim 10, wherein the PM metric comprises at least one of:
service consumption;
traffic generated;
mobility;
cell load;
radio quality; and
service performance,
wherein the CM metric comprises at least one of:
spectrum;
antenna configuration; and
cell dimensioning, and
wherein the latent parameter comprises at least one of:
a licensed measurement report; and
a third party data service.

12. A method of operating an explainer with ordering constraints for a machine learning (“ML”) model, the method comprising:
determining an issue associated with a label of the ML model based on input data, the input data associated with a plurality of categorized features;
determining a root cause of the issue based on a causality relationship between the plurality of categorized features; and
performing an action based on the root cause of the issue.

13. The method of claim 12, further comprising:
determining a plurality of categories associated with a plurality of features of the ML model; and
determining a causality relationship between the plurality of categories.

14. The method of claim 12, wherein determining the root cause of the issue comprises using an asymmetric Shapley Additive Explanation (“SHAP”) as a model explainer with ordering constraints from the causality relationship between each category of the plurality of categories.

15. The method of claim 12, wherein the ML model is configured to evaluate a communications network,
wherein the plurality of features comprise at least one of:
a performance management (“PM”) metric associated with an activity of a communication device in the communications network;
a configuration management (“CM”) metric associated with a parameter of the communications network; and
a latent parameter that is not currently measured.

16. The method of claim 15, wherein the PM metric comprises at least one of:
service consumption;
traffic generated;
mobility;
cell load;
radio quality; and
service performance,
wherein the CM metric comprises at least one of:
spectrum;
antenna configuration; and
cell dimensioning, and
wherein the latent parameter comprises at least one of:
a licensed measurement report; and
a third party data service.

17. The method of claim 15, wherein performing the action comprises:
transmitting instructions to a network node to reconfigure the communications network to reduce the issue.

18. The method of claim 12, wherein performing the action comprises outputting an indication of at least one of:
a latent feature that had at least a threshold impact on the label;
a reconfiguration suggestion based on the root cause; and
an amount that a feature affected the label.

19. The method of claim 12, wherein performing the action comprises adjusting a type of input data used by the ML model.

20. A non-transitory computer readable medium having instructions stored therein that are executable by a system including an explainer with ordering constraints to perform operations comprising:
determining an issue associated with a label of a machine learning (“ML”) model based on input data, the input data associated with a plurality of categorized features;
determining a root cause of the issue based on a causality relationship between the plurality of categorized features; and
performing an action based on the root cause of the issue.
